(19) United States
(12) Patent Application Publication
(10) Pub. No.: US 2023/0286248 A1
(43) Pub. Date: Sep. 14, 2023

(54) METHOD OF MANUFACTURING FLAME-RETARDANT RAYON STAPLE FIBER LAMINATE MADE FROM RAYON STAPLE FIBER AND FLAME-RETARDANT RAYON STAPLE FIBER LAMINATE MANUFACTURED THEREBY

(71) Applicants: Sang Young Maeng, Gwangju-si, Gyeonggi-do (KR); Young Hur, Seoul (KR)

(72) Inventors: Young HUR, Seoul (KR); Yoon Tae PARK, Siheung-si, Gyeonggi-do (KR)

(21) Appl. No.: 18/043,916

(22) PCT Filed: Sep. 14, 2021
(86) PCT No.: PCT/KR2021/012499

§ 371 Date: Mar. 3, 2023

(30) Foreign Application Priority Data
Sep. 16, 2020 (KR) 10-2020-0118763

(51) Int. Cl. B32B 5/26; D04H 1/498; D04H 18/02; D04H 1/4258; B32B 5/02; B32B 5/06; D04H 1/413

(52) U.S. Cl. CPC B32B 5/266; D04H 1/498; D04H 18/02; D04H 1/4258; B32B 5/022; B32B 5/06; D04H 1/413; B32B 2260/023; B32B 2260/04; B32B 2307/718; B32B 2262/04; B32B 2250/20; B32B 2307/3065; D10B 2401/04; B32B 2264/1021

(57) ABSTRACT

Disclosed are a method of manufacturing a flame-retardant rayon staple fiber, and a flame-retardant rayon staple fiber laminate made from the same staple fiber. The method includes a step of impregnating a flame-retardant staple fiber web with a flame-retardant solution in which a starch and an inorganic powder are mixed and a step of drying the impregnated staple fiber web. When the flame-retardant rayon staple fiber is manufactured by the method, inorganic particles absorbed by the staple fiber do not easily detach, thereby improving flame retardancy of the fiber. When a staple fiber laminate is made from the staple fiber manufactured by the method, the strength of the laminate is improved due to the presence of the starch, and the workability and moldability of the laminate are also improved due to the increased strength.

### BACKGROUND OF THE INVENTION

### Field of the Invention

The present invention relates to a method of manufacturing a flame-retardant staple fiber laminate made from rayon staple fibers and to a flame-retardant rayon staple fiber laminate manufactured thereby. More specifically, the present invention relates to a method of manufacturing a flame-retardant staple fiber laminate made from rayon staple fibers and to a flame-retardant rayon staple fiber laminate manufactured by the method in which a staple fiber web is impregnated with a flame-retardant solution that is a mixture of a starch-based paste (hereinafter, simply referred to as a starch paste) and a silica aqueous dispersion solution and is then dried. The flame-retardant staple fiber laminate thus manufactured has improved flame retardancy because silica powder adhered to the staple fibers are minimally detached due to the presence of the starch and exhibits improved processability and moldability because the laminate has increased strength due to the use of staple fibers and the presence of starch.

### Description of the Related Art

Since building materials, industrial materials, and the like largely use insulating materials such as rock wool, gypsum plate, glass fiber, and Styrofoam, and hard plates composed of compressed wood and adhesives, there is a problem in that the plates emit substances harmful to the human body and cannot be recycled, thereby being sources of environmental pollution.

Conventionally, a method of manufacturing a plate using waste fibers is known. For example, Korean Unexamined Patent Publication No. 87-5764 discloses a chemical fiber pressure plate that is manufactured by a method in which a web is obtained by finely crushing fibrous polypropylene, cutting chemical fibers made of acryl fiber, polyester, nylon and the like into staples having sizes equal to or larger than 10 mm, and putting the crushed fibrous polypropylene and chemical fiber staples into a carding machine, the web is heated in a heating chamber for a predetermined period of time, and then the heated web is cut to form chemical fiber pressure plates. However, this chemical fiber pressure plate manufactured by this method has the disadvantage of being easily broken due to little entanglement of the staple fibers because chemical fibers are cut into staple fibers having sizes of about 10 mm. In addition, the plates are unsuitable as interior materials for buildings because they generate smoke and harmful gases if catching fire.

On the other hand, Korean Patent Publication No. 95-6863 discloses a method of manufacturing a chemical fiber plate. In the method, waste fibers are cut into relatively long fibers of about 50 to 100 mm, blown on a blowing machine to form a web, and are formed into a mat of a predetermined thickness, and then laminated in layers of appropriate thickness, and heated and pressed at high temperature and high pressure so that fibers are integrated with each other. However, since the chemical fiber plate manufactured by the above-described method is formed at high temperature and high pressure, a polymer material constituting the fibers is likely to compose under the harsh conditions, thereby losing the unique properties thereof.

As a solution to this problem, there is a method of manufacturing a polyester fiber plate by fusing a web composed of commonly-used polyester fibers and low-melting point polyester fibers. Although this polyester fiber plate is suitable as a building interior material in terms of the properties of heat retention, heat insulation, shock absorption, elasticity, and esthetic exterior thereof, it still has the problem of insufficient flame retardancy and is thus vulnerable to fire.

In addition, since chemical fibers are used in the above-described conventional methods, the working environment is poor and environmental pollutants are generated. In addition, these plates are unsuitable as interior materials for buildings due to the generation of smoke and harmful gases when being burned.

As a solution to these problems described above, rayon fiber that is impregnated with a flame-retardant solution in which an inorganic powder is contained and then dried has been used. However, the laminate made from conventional rayon fiber has a problem in that the inorganic powder remaining on the surface of the staple fiber falls off and generates particles that will scatter in the air. Even though the inorganic powder on the surface of the staple fiber is dusted off, since the inorganic powder that has penetrated into the fiber is not fixed in the fiber, the inorganic powder may come out to the surface. As a result, the flame retardancy of the staple fiber is deteriorated over time. Moreover, since the staple fiber laminate made from existing rayon staple fibers is significantly low in strength, the moldability and workability thereof are poor.

To increase the strength of the staple fiber laminate to compensate for the problems occurring in the related art, staple fibers need to be laminated to a considerable thickness and then pressed to have high density and strength. In this case, the strength of the stable fiber laminate may increase due to the high-density compression, but there is a problem in that the sound absorbing property decreases. In addition, since a large number of staple fibers are used, a large amount of waste is generated when the staple fiber laminate is discarded.

### DETAILED DESCRIPTION OF THE INVENTION

### Technical Solution

The present invention has been made in view of the problems occurring in the related art, and the objective of the present invention is to provide a method of manufacturing a flame-retardant staple fiber laminate made from rayon staple fibers and to a flame-retardant rayon staple fiber laminate manufactured by the method in which a staple fiber web is impregnated with a flame-retardant solution that is a mixture of a starch paste and a silica aqueous dispersion solution and dried. The flame-retardant staple fiber laminate thus manufactured has improved retardancy because silica powder adhered to the staple fibers is hardly detached due to the presence of the starch and exhibits improved processability and moldability because the laminate has increased strength due to the use of staple fibers and the presence of starch.

### SUMMARY OF THE INVENTION

In the method for manufacturing a staple fiber laminate having flame retardancy using rayon staple fibers of the present invention that solves the above problems, the method including: opening staple fibers using an opening machine and forming a web with a predetermined thickness and width from the resulting opened fibers using a carding machine S100; stacking the webs output from the carding machine to a predetermined thickness to obtain a web laminate S200; needle-punching the web laminate so that the webs in the web laminate are entangled not to be scattered but to be maintained orderly by a binding force therebetween S300; impregnating the needle-punched web laminate with a flame-retardant solution, the impregnating including: a first process of preparing a silica aqueous dispersion solution by mixing 25 to 30 parts by weight of silica powder, 65 to 72 parts by weight of distilled water, and 3 to 5 parts by weight of acetic acid; a second process of preparing a condensation reaction solution by mixing 34 to 41 parts by weight of alkoxysilane, 4 to 6 parts by weight of a photocatalyst, and 55 to 60 parts by weight of the silica aqueous dispersion solution, using a mixer; and impregnating the web laminate with the flame-retardant solution formed by mixing a mixed solution and a starch paste in a mixing ratio of 9:1 to 8:2 in terms of parts by weight, the mixed solution being prepared by mixing 25 to 35 parts by weight of the condensation reaction solution, 55 to 70 parts by weight of silicate, and 5 to 10 parts by weight of propylene, in which the impregnating makes the web laminate absorb the flame-retardant solution S400; causing the web laminate to pass between a pair of rolls to dehydrate the web laminate S500;

removing inorganic particles attached to the surfaces of the dehydrated web laminate by suctioning air from the underside of the web laminate and blowing air downward from above the web laminate S600; and drying the web laminate having wettability after performing the removing of inorganic particles S700.

In the impregnating, the web laminate is impregnated in a mixture mixed with silica powder and dried to absorb the mixture to remove moisture, and then the web laminate is secondarily impregnated in the flame retardant formed by mixing starch paste with the mixture.

The mixed solution includes a first stage at which 25 to 30 parts by weight of silica powder, 65 to 72 parts by weight of distilled water, and 3 to 5 parts by weight of acetic acid are fixed to obtain the silica aqueous dispersion solution, a second stage at which 34 to 41 parts by weight of alkoxysilane, 4 to 6 parts by weight of a photocatalyst, and 55 to 60 parts by weight of the silica aqueous dispersion solution prepared at the first stage are mixed using a mixer and the mixture undergoes a polymerization reaction to obtain the condensation reaction solution, and a third stage at which 55 to 70 parts by weight of silicate and 5 to 10 parts by weight of propylene are mixed with 25 to 35 parts by weight of the condensation reaction solution to obtain the flame-retardant solution.

The polymerization reaction is performed for 8 hours or more while a reaction heat is generated so that a reaction temperature becomes 65° C. to 75° C.

In the staple fiber laminate manufactured by the manufacturing method of the present invention, if a web composed of a flame-retardant rayon staple fiber laminate is impregnated in a flame-retardant solution mixed with a starch-based paste and a silica water dispersion solution and dried, the silica powder is adsorbed to the staple fiber by the starch paste and is not removed, thereby increasing flame retardant efficiency. When the laminate is formed using the web described above, a flame-retardant rayon staple fiber laminate is made, which improves processability and moldability by improving the strength of starch.

On the other hand, silica powder is adsorbed inside the rayon stable fiber, and the silica powder is adsorbed with starch paste, and starch paste is adsorbed outside.

### Effect of the Invention

The present invention does not have a problem in that the powder is blown because inorganic powder (a flame-retardant agent) does not remain on the surface of the short fiber and has an advantage in that the inorganic powder impregnated into the fiber is not discharged to the outside even after time elapses. The flame retardant rayon staple fiber manufactured by the method of manufacturing the flame retardant rayon staple fiber of the present invention has the excellent quality, and inorganic powder is fixed inside the fiber over time, so there is no problem of degrading flame retardancy. Even when a small amount of staple fiber is used in the manufacturing method, which was compressed with high density to have the strength after a large amount of staple fiber is thickly stacked, moldability, processability, and sound absorption are improved, and a small amount of staple fiber is generated when the staple fiber laminate is discarded.

### BRIEF DESCRIPTION OF THE DRAWINGS

FIG. 1 is an exemplary view illustrating a method of manufacturing a flame-retardant rayon staple fiber according to one embodiment of the present invention;

FIG. 2 is a manufacturing process diagram showing another embodiment of the present invention;

FIG. 3 is an exemplary view showing an example of an impregnation step that is the technical gist of the present invention;

FIG. 4A is a cross-sectional view of a staple fiber that is impregnated with a solution mixture used in the present invention;

FIG. 4B is a cross-sectional view of a staple fiber impregnated with a flame-retardant solution used in the present invention; and

FIG. 4C is a cross-sectional view of a staple fiber that has undergone a primary impregnation process in which a solution mixture is used, a drying process, and a secondary impregnation process in which a flame-retardant solution is used.

### DESCRIPTION OF THE PREFERRED EMBODIMENTS

Hereinafter, a preferred embodiment of the present invention will be described in detail with reference to the accompanying drawings.

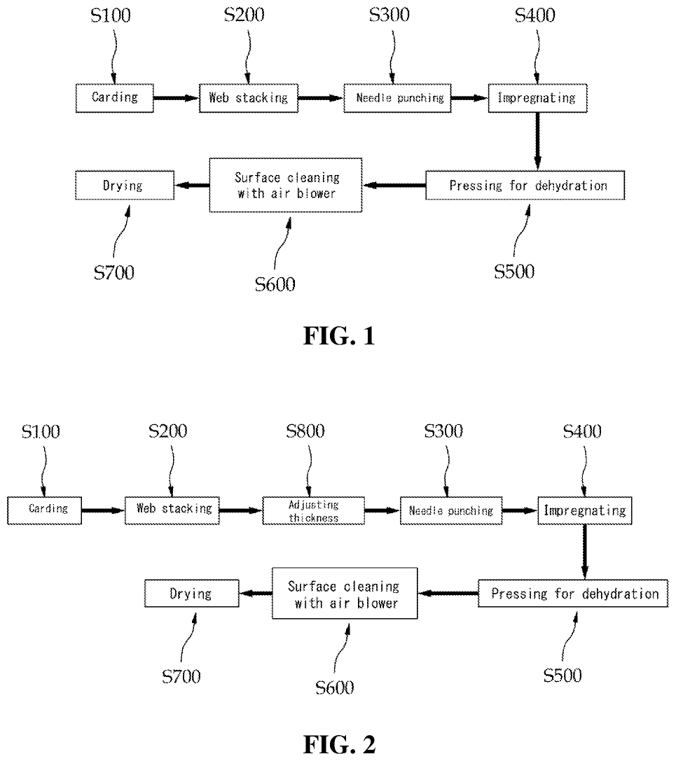

FIG. 1 is an exemplary view illustrating a method of manufacturing a flame-retardant rayon staple fiber according to the present invention. The manufacturing method of the present invention includes a carding step S100 in which staple fibers are opened with a fleece-like yarn using an opening machine, and then the opened staple fibers are carded by a carding machine with a predetermined thickness and width to form a web. The staple fibers used in the present invention are fibers capable of absorbing a flame-retardant solution to be described later. For example, the fibers may be natural fibers, rayon fibers, or hybrid fibers obtained by mixing rayon and LM yarn.

Next, a web lamination step S200 is performed. In this step, the web formed by the carding machine is evenly spread on a conveying belt. This web lamination step S200 is repeated a predetermined number of times using a web laminating machine to obtain a web laminate having a predetermined thickness.

When the staple fiber laminate is manufactured through the web lamination step S200, a needle punching step S300 is performed. In the step, the laminated web is needle-punched with a needle punching machine so that webs stacked in the laminate are entangled not to be scattered and to be maintained in an orderly state by a binding force therebetween.

Referring to FIG. 2, between the web lamination step S200 and the needle punching step S300, a thickness control step S800 may be optionally performed to form a staple fiber laminate having a predetermined thickness. In this step, the web laminate resulting from the web lamination step S200 is conveyed along a conveying belt and is made to pass through a heating and compressing machine. After passing through the heating and compressing machine, the web laminate may be thinned so that the thickness thereof changes from 300 mm to 50 mm.

After the laminated web undergoes the thickness control step S800, the needle punching step S300 is performed. That is, the laminated web is needle-punched with a needle punching machine so that the laminated webs are entangled not to be scattered but to be maintained in an orderly arranged state by a binding force therebetween.

Next, as illustrated in FIGS. 1 to 2, a first step, a second step, and an impregnation step S400 are performed. In the first step, an silica aqueous dispersion solution is prepared by mixing 25 to 30 parts by weight of silica powder, 65 to 72 parts by weight of distilled water, and 3 to 5 parts by weight of acetic acid. In the second step, 34 to 41 parts by weight of alkoxysilane and 4 to 6 parts by weight of a photocatalyst are mixed with 55 to 60 parts by weight of the silica aqueous dispersion solution prepared by the first step, and the mixture is polymerized. Next, in the impregnation step S400, the web laminate is impregnated with the flame-retardant solution formed by mixing a mixed solution and a starch paste in a mixing ratio of 9:1 to 8:2 in terms of parts by weight, the mixed solution being prepared by mixing 25 to 35 parts by weight of the condensation reaction solution, 55 to 70 parts by weight of silicate, and 5 to 10 parts by weight of propylene, wherein the impregnating makes the web laminate absorb the flame-retardant solution.

In the process of preparing the flame retardant solution, the lower limit of the range of parts by weight of each component used is set to a value at which the surface hardness of the web laminate is slightly insufficient but the adhesion is excellent, and the upper limit is set to a value at which the surface hardness is excellent but the adhesion is slightly insufficient. On the other hand, a fluorocarbon resin powder may be mixed with the inorganic powder.

The silica powder and the fluorocarbon resin powder used herein have a particle size of 100 to 200 mesh. When the particle size is equal to or smaller than 100 mesh, the powders easily come out of the rayon fiber after drying whereas when the particle size is larger than 200 mesh, the powders are difficult to permeate into the rayon fiber and are present only on the surface of the rayon fiber.

The silica powder is non-flammable, and the fluorocarbon resin powder has an effect of delaying ignition and melts and flows down when catching fire, thereby suppressing the fire from easily spreading.

In addition, since inorganic powder, i.e., silica powder, absorbs moisture as much as 2 to 3 times the volume thereof during fire extinguishment and normally contains moisture captured therein, the inorganic powder plays a role of suppressing the ignition by emitting the captured moisture during the ignition although rayon fibers are ignited.

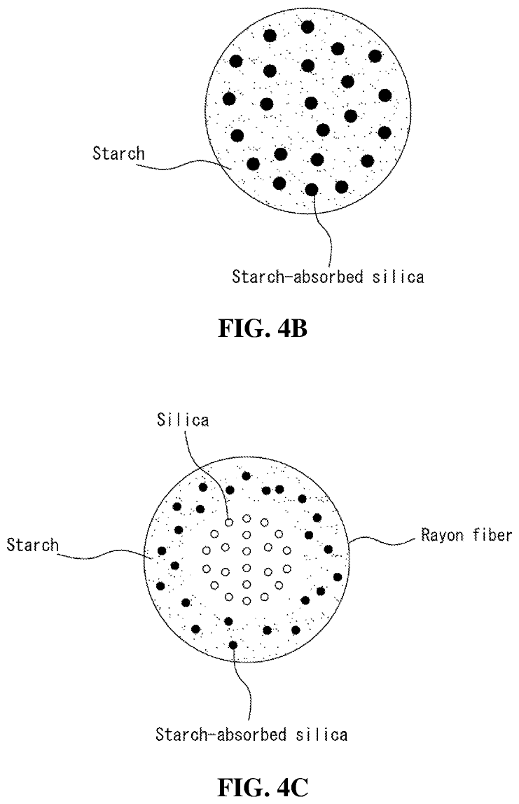

Referring to FIG. 4A, in the impregnation step S400, when observing the cross-section of the rayon fiber that is impregnated with a mixed solution containing no starch, only inorganic particles, i.e., silica particles are present in the rayon fiber. The silica particles disposed near the surface of the rayon fiber easily escapes while undergoing a dehydration step S500, a surface cleaning step S600, and a drying step S700 to be described below.

However, referring to FIG. 4B, when the rayon fibers are impregnated with the flame-retardant solution, the starch permeates into the rayon fibers, and the silica particles retaining the starch permeated thereinto also permeates into the rayon fibers. Therefore, the starch and the silica particles absorbed by the rayon fiber do not easily escape from the rayon fibers while undergoing the dehydration step S500, the surface cleaning step S600, and the drying step S700. However, since only a small amount of starch can be absorbed by the rayon fiber due to the nature of the starch paste, the amount of silica particles absorbed by the rayon fiber is also small.

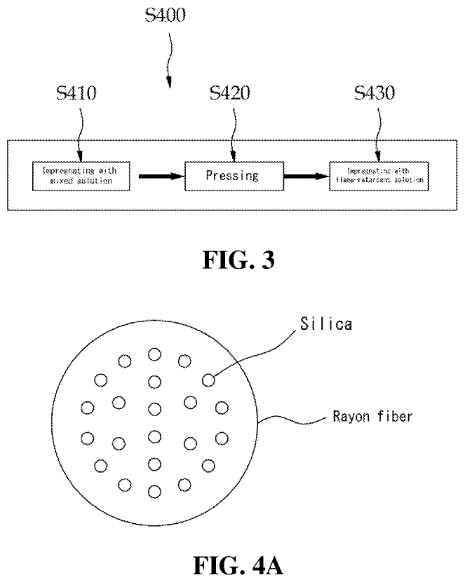

Taking into account this property, the impregnation step (S400) is preferably divided into two stages: first stage of impregnation with the mixed solution and second stage of impregnation with the flame retardant solution, as illustrated in FIG. 3. In this case, as shown in FIG. 4C, the silica particles with no starch absorbed therein is present at a relatively inner portion (i.e. radially center portion) in the rayon fiber, and the silica particles retaining the starch absorbed therein is present in a relatively outer portion (i.e., near the surface) in the rayon fiber, the silica particles with no starch absorbed therein cannot escape from the rayon fiber and remains captured in the rayon fiber.

Meanwhile, since the flame-retardant solution is absorbed by the web laminate in the impregnation step S400, the dehydration step S500 is performed in a manner that the web laminate passes between a pair of rolls so that the flame-retardant solution is squeezed out of the web laminate. In the dehydration step S500, it is preferable to use a pair of mangle rolls that are mesh-type rolls, in terms of easily discharging moisture while the web laminate is pressed by the rolls.

When the dehydration step S500 is completed as described above, the surface cleaning step S600 of suctioning air from the underside of the web laminate while blowing air downward from above the web laminate is performed to remove the inorganic particles attached to the surface of the dehydrated web laminate. Specifically, in this step, the laminate moves along the conveyer belt, and air is blown downward from above the web laminate through a nozzle. The conveyer belt has many holes or the conveyer belt is a mesh-type conveying belt, so that the air can be sucked from the underside of the conveyer belt.

The reason for using air in the surface cleaning step S600 is to remove the inorganic particles adsorbed on the surface of the staple fibers while the air passes through the gaps between each of the staple fibers and to dry the surface of the staple fibers. The air suctioning must be performed because, when the air blowing is performed but the air suctioning is not performed, there is a problem in that air cannot pass through the laminate.

After performing the surface cleaning step S600, the drying step S700 is performed to dry the web laminate. In the drying step S700, a dryer or an oven is used, and the heating temperature is in a range of 60° C. to 90° C. The heating temperature range is set to prevent the rayon fiber from being deformed.

The maximum heat releasing rate, shrinkage rate, and elasticity of the staple fiber laminate (floss) of the present invention and the conventional staple fiber laminate (floss) prepared as described above were investigated through the tests described below.

Test method: KS F 2271

Test method: KS F ISO 5660-1 (combustion performance test)

Test Conditions:

### Comparative Example 1

A staple fiber laminate having a weight of 780 g/m² and a thickness of 8 mm was prepared using a fiber made of 100% having a thickness of 5.6 denier and a length of 64 mm. The staple fiber laminate was needle-punched, impregnated with a ceramic flame-retardant solution (which is a one-component room temperature curing-type eco-friendly water-soluble inorganic ceramic resin available from Elko City Co., Ltd.), and dried.

### Experimental Example 1

A staple fiber laminate having a weight of 780 g/m² and a thickness of 8 mm was prepared using a fiber made of 100% having a thickness of 5.6 denier and a length of 64 mm. The staple fiber laminate was needle-punched, impregnated with the flame-retardant solution used in the present invention, and dried.

### Experimental Example 2

A staple fiber laminate having a weight of 780 g/m² and a thickness of 8 mm was prepared using a fiber made of 100% having a thickness of 5.6 denier and a length of 64 mm. The staple fiber laminate was needle-punched, primarily impregnated with the mixed solution used in the present invention and dried, and secondarily impregnated with the flame-retardant solution used in the present invention and dried.

TABLE 1

| | Comparative | | |
|---|---|---|---|
| | Example | Example 1 | Example 2 |
| After flame | 6 seconds | None | None |
| Exterior | Clean | Clean | Clean |
| Elasticity | Good | Hard | Very hard |
| Maximum heat | 85.1 | 68.3 | 61.4 |
| releasing rate | | | |
| (Kw/m²) | | | |
| Shrinkage (%) | 8.3 | 6.5 | 4.6 |

As shown in Table 1 above, it is found that, when the webs constituting the web laminate are impregnated through two stages in which the webs are primarily impregnated with the mixed solution and then secondary impregnated with the flame-retardant solution, the flame-retardant solution can permeate deep into the web laminate. Therefore, the flame retardancy of the stable fiber web laminate is improved. In addition, the elasticity of the stable fiber web laminate is lowered because the hardness of the staple fibers is increased due to the starch imparts strong adhesion to the staple fibers.

The present invention as described above is a useful invention because there is no problem of powder scattering because an inorganic powder (flame-retardant) is not present on the surface of the staple fiber, and the inorganic powder that has penetrated into the fiber cannot escape from the inside of the fiber even after a long time of use. Therefore, the flame-retardant rayon staple fiber manufactured by the method of the present invention is excellent in quality and is free from decreasing in the flame retardancy over time. In addition, the staple fiber laminate made from the flame-retardant rayon staple fiber manufactured by the method of the present invention has increased strength while using a reduced amount of staple fibers compared to conventional counterparts that are manufactured by forming, first, a thick staple fiber laminate and then compressing the thick staple fiber laminate to a reduced thickness to increase the strength. Therefore, the staple fiber laminate made from the flame-retardant rayon staple fiber manufactured by the method of the present invention has improved moldability, processability, and sound absorption properties, and generates a small amount of waste when discarded.

### DESCRIPTION OF THE REFERENCE NUMERALS IN THE DRAWINGS

S100 carding
S200 web stacking
S300 needle punching
S400 impregnating
S500 pressing for dehydration
S600 surface cleaning with air blower
S700 drying
S800 adjusting thickness

1. A method of manufacturing a flame-retardant staple fiber laminate made from rayon staple fibers, the method comprising:
opening staple fibers using an opening machine and forming a web with a predetermined thickness and width from the resulting opened fibers using a carding machine;
stacking the webs output from the carding machine to a predetermined thickness to obtain a web laminate;
needle-punching the web laminate so that the webs in the web laminate are entangled not to be scattered but to be maintained orderly by a binding force therebetween;
impregnating the needle-punched web laminate with a flame-retardant solution, the impregnating including:
preparing a silica aqueous dispersion solution by mixing 25 to 30 parts by weight of silica powder, 65 to 72 parts by weight of distilled water, and 3 to 5 parts by weight of acetic acid;
preparing a condensation reaction solution by mixing 34 to 41 parts by weight of alkoxysilane, 4 to 6 parts by weight of a photocatalyst, and 55 to 60 parts by weight of the silica aqueous dispersion solution, using a mixer;
impregnating the web laminate with the flame-retardant solution formed by mixing a mixed solution and a starch paste in a mixing ratio of 9:1 to 8:2 in terms of parts by weight, the mixed solution being prepared by mixing 25 to 35 parts by weight of the condensation reaction solution, 55 to 70 parts by weight of silicate, and 5 to 10 parts by weight of propylene, wherein the impregnating makes the web laminate absorb the flame-retardant solution;
causing the web laminate to pass between a pair of rolls to dehydrate the web laminate;
removing inorganic particles attached to the surfaces of the dehydrated web laminate by suctioning air from the underside of the web laminate and blowing air downward from above the web laminate; and
drying the web laminate having wettability after performing the removing of inorganic particles.

2. The method of claim 1, wherein the impregnating comprises:
a primary impregnation process in which the web laminate is primarily immersed in the mixed solution containing the inorganic particles so that the web laminate absorbs the mixed solution, followed by dehydration; and
a secondary impregnation process in which the web laminate having undergone the primary impregnation and the dehydration is secondarily immersed in the flame-retardant solution obtained by adding the starch paste to the mixed solution.

3. The method of claim 1, wherein the preparation of the mixed solution comprises:
a first stage at which 25 to 30 parts by weight of silica powder, 65 to 72 parts by weight of distilled water, and 3 to 5 parts by weight of acetic acid are fixed to obtain the silica aqueous dispersion solution;
a second stage at which 34 to 41 parts by weight of alkoxysilane, 4 to 6 parts by weight of a photocatalyst, and 55 to 60 parts by weight of the silica aqueous dispersion solution prepared at the first stage are mixed using a mixer and the mixture undergoes a polymerization reaction to obtain the condensation reaction solution; and
a third stage at which 55 to 70 parts by weight of silicate and 5 to 10 parts by weight of propylene are mixed with 25 to 35 parts by weight of the condensation reaction solution to obtain the flame-retardant solution.

4. The method of claim 1, wherein the silica powder is mixed with a fluorocarbon resin powder.

5. The method of claim 1, wherein the polymerization reaction is performed for 8 hours or more while a reaction heat is generated so that a reaction temperature becomes 65° C. to 75° C.

6. A flame-retardant rayon staple fiber laminate that is obtained by impregnating a staple fiber web with a flame-retardant solution in which a starch paste and a silica aqueous dispersion solution are mixed, and by drying the staple fiber web so that silicon powder absorbed by the staple fiber web does not easily detach from the stable fiber web due to the presence of the starch, thereby improving flame retardancy and strength of the staple fiber web and improving workability and moldability of the staple fiber web,
wherein the silicon powder is present inside the rayon staple fiber, and the starch paste and the silicon powder coated with the starch paste are present on a surface of the staple fiber web.
